(19) United States
(12) Patent Application Publication
(10) Pub. No.: US 2008/0183959 A1
(43) Pub. Date: Jul. 31, 2008

(54) MEMORY SYSTEM HAVING GLOBAL BUFFERED CONTROL FOR MEMORY MODULES

(76) Inventors: Perry H. Pelley, Austin, TX (US); Lucio F. C. Pessoa, Cedar Park, TX (US); William C. Moyer, Dripping Springs, TX (US)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 11/668,267

(22) Filed: Jan. 29, 2007

(51) Int. Cl. G06F 12/00

(52) U.S. Cl. 711/109; 711/149; 711/100; 711/E12.001

(57) ABSTRACT

A memory system has a plurality of memory modules and a global memory buffer. Each of the plurality of memory modules has at least two integrated circuit memory chips. The global memory buffer has a plurality of ports, each port coupled to a respective one of the plurality of memory modules. The global memory buffer stores information that is communicated with the plurality of memory modules. The global memory buffer has a communication port for coupling to a high-speed communication link.

### BACKGROUND

1. Field

This disclosure relates generally to semiconductors, and more specifically, to semiconductor memories and access control thereof.

2. Related Art

Computer memory systems are commonly implemented using memory modules in which at least two integrated circuit memories (i.e. chips) are provided on a same printed circuit (PC) board. Such memory modules are commonly referred to as a single inline memory module (SIMM) or a dual inline memory module (DIMM). A SIMM contains two or more memory chips with a thirty-two bit data bus and a DIMM contains two or more memory chips with a sixty-four bit data bus. Sometimes parity bits are added to a SIMM or DIMM and the data bus widths are increased. In a conventional memory system a processor requests a memory access by making an access request to a memory controller. The memory controller communicates sequentially with each of a plurality of memory modules. Each memory module has control circuitry known as a repeater. The presently highest speed memory modules are fully buffered DIMM. Each fully buffered DIMM has a high speed transceiver and control integrated circuit in addition to the memory integrated circuits. The memory controller communicates with the control circuitry provided on a first memory module. The control circuitry determines if a memory access address is assigned to any memory space within the first memory module. If not, the transaction is passed to the control circuitry of a next successive memory module where the address evaluation is repeated until all of the memory modules have been checked to determine if they have been addressed. In this memory system architecture, the access of a memory module involves the sequential querying of a plurality of memory modules to determine the location of the address for access. The daisy chaining of all memory modules avoids the capacitive and inductive loading effects that would detrimentally slow memory accesses.

The use of a controller circuit or a buffer circuit in each memory module provides individual access to each of a plurality of memory chips within a single memory module. While the fully buffered DIMM provides a high bandwidth solution it is expensive and dissipates substantially more power and adds latency when more than one DIMM is used.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 illustrates in block diagram form a memory system having global buffering in accordance with one form of the present invention;

FIG. 2 illustrates in block diagram form one form of a global memory buffer illustrated in FIG. 1; and

FIG. 3 illustrates in block diagram form an implementation of buffer memory illustrated in FIG. 2.

### DETAILED DESCRIPTION

As used herein, the term “bus” is used to refer to a plurality of signals or conductors which may be used to transfer one or more various types of information, such as data, addresses, control, or status. The conductors as discussed herein may be illustrated or described in reference to being a single conductor, a plurality of conductors, unidirectional conductors, or bidirectional conductors. However, different embodiments may vary the implementation of the conductors. For example, separate unidirectional conductors may be used rather than bidirectional conductors and vice versa. Also, a plurality of conductors may be replaced with a single conductor that transfers multiple signals serially or in a time multiplexed manner. Likewise, single conductors carrying multiple signals may be separated out into various different conductors carrying subsets of these signals. Alternatively, wireless links may be used to transmit multiple signals. Therefore, many options exist for transferring signals.

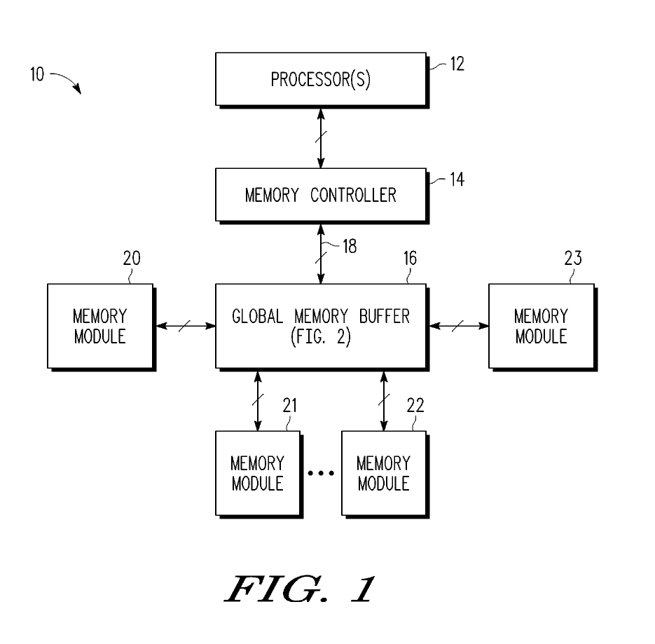

Illustrated in FIG. 1 is a memory system 10 in accordance with one form of the disclosed teachings. Memory system 10 has one or more processors 12. Many data processing systems use multiple processors or processing cores. Each of the one or more processors 12 is connected to a first input/output (I/O) terminal or port of a memory controller 14 via a first high-speed communication channel. The memory controller 14 is a conventional memory controller and functions to control and coordinate data communication to and from the one or more processors 12. Memory controller 14 has a second input/output (I/O) connected to a first input/output terminal of a global memory buffer 16 via a second high speed communication channel 18. The high-speed communication channel 18 may be an optical link such as an optical waveguide in one form. Other forms include conductive metal links using low voltage differential signaling (LVDS), or RF wireless connections such as ultra wideband (UWB) in which the transmitted signal spectrum may be in a range of approximately three to ten gigahertz (3-10 GHz). The terms “channel”, “link” and “connection” that are used herein are interchangeable and represent a means for communicating information. In alternate embodiments any combination of LVDS, UWB and optical links may also be used in the high-speed communication channel 18. As used herein, the term “high-speed” is intended to broadly cover a wide bandwidth of frequencies. In other words the terms “high-speed” and “high-bandwidth” are used interchangeably. Therefore, the specific frequency which is implemented in the embodiments disclosed herein is not as relevant as the bandwidth which is implemented. The bandwidths contemplated herein are expected to support data rates of at least three gigabits per second (3 Gbps) with no specific maximum value.

The global memory buffer 16 has a second input/output terminal connected to an input/output terminal or port of a memory module 20. A third input/output terminal of the global memory buffer 16 is connected to an input/output terminal of the memory module 21. A fourth input/output terminal of the global memory buffer 16 is connected to an input/output terminal of a memory module 22. A fifth input/output terminal of the global memory buffer 16 is connected to an input/output terminal of a memory module 23. Each of the memory modules 20-23 is a plurality of integrated circuit memory chips. However, the memory modules 20-23 do not contain buffer circuits or repeater circuits and may be implemented as low-cost DIMM or SIMM PC boards. Additionally, any number of memory modules such as memory modules 20-23 may be implemented and connected to the global memory buffer 16 as indicated by the three dots separating memory module 21 from memory module 22. Thus in memory system 10 a single or centralized memory buffer is provided to implement the communication (i.e. writing and reading) of data between the one or more processors 12 and each of the memory modules 20-23. It should be noted that the buses that are connected between each of memory modules 20-23 and the global memory buffer 16 are a lower speed communication bus than the high-speed bus of communication channel 18. The result of this design feature is that the buses connected directly to the memory modules 20-23 will cost less and consume less power. Additionally, the effective data rate of memory system 10 is not compromised by the strategic use of these lower bandwidth buses connected directly to the memory modules 20-23 as a result of the global memory buffer 16 centrally managing the memory system 10. The parallelism of the data paths associated with memory modules 20-23 and a centralized global memory buffer 16 permits efficient data communication with a high-speed communication link without using high-speed buses in all data paths.

As will be explained below, there can be communication of data directly between each of the memory modules 20-23 without involving the memory controller 14.

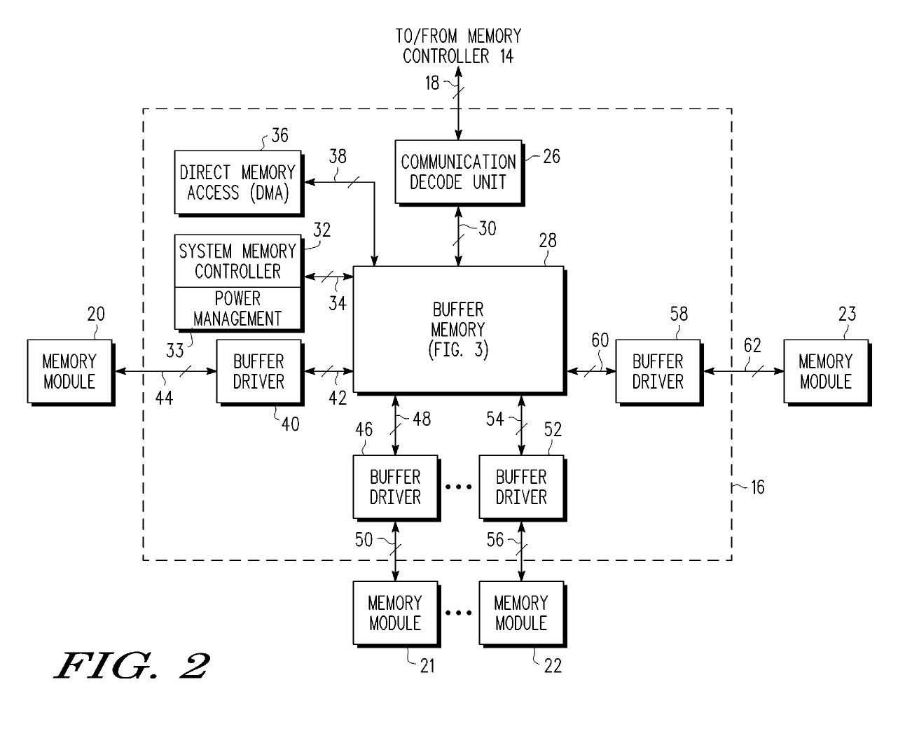

Illustrated in FIG. 2 is a block diagram of one form of the global memory buffer 16 of FIG. 1. The high speed communication channel 18 is connected to a first input/output terminal of a communication decode unit 26. A second input/output terminal of the communication decode (encode) unit 26 is connected to a first input/output terminal or port of a buffer memory 28 via a bus 30. A direct memory access (DMA) 36 is connected to a second input/output terminal of the buffer memory 28 via a bus 38. The DMA 36 is a conventional DMA circuit and therefore further details of the DMA 36 are not provided. A system memory controller 32 has an input/output terminal connected to a third input/output terminal of the buffer memory 28 via a bus 34 for controlling reading, writing and refreshing memory modules 20-23 via buffer memory 28. In another embodiment the system memory controller 32 may provide test functions for memory modules 20-23. System memory controller 32 further has logic circuitry for implementing a power management unit 33 which functions to control power supply values and clock rates within the memory system based on predetermined criteria to be described below. A buffer driver 40 has a first input/output terminal connected to a fourth input/output terminal of the buffer memory 28 via a bus 42. A second input/output terminal of the buffer driver 40 is connected to the input/output terminal of memory module 20 via a bus 44. The buffer drivers described herein are conventional driver circuits and therefore further details of such buffer drivers are not provided. A buffer driver 46 has a first input/output terminal connected to a fifth input/output terminal of the buffer memory 28 via a bus 48. A second input/output terminal of the buffer driver 46 is connected to the input/output terminal of memory module 21 via a bus 50. A buffer driver 52 has a first input/output terminal connected to a sixth input/output terminal of the buffer memory 28 via a bus 54. A second input/output terminal of buffer driver 52 is connected to the input/output terminal of memory module 22 via a bus 56. A buffer driver 58 has a first input/output terminal connected to a seventh input/output terminal of buffer memory 28 via a bus 60. A second input/output terminal of buffer driver 58 is connected to the input/output terminal of memory module 23. In the illustrated form each of buses 30, 38, 34, 42, 44, 48, 50, 54, 56, 60 and 62 is a multiple bit-wide conductor as indicated by the “slash” on each of the conductors.

In operation, the global memory buffer 16 functions as a global or central memory buffer to each of the separate memory modules 20-23. The design-specific number of memory modules that is connected to the buffer memory 28 is provided without loading the buffer memory significantly as the memory modules are decoupled from each other. Additionally, the buses 30, 34, 38, 42, 48, 54 and 60 provide relatively short point-to-point buses between the buffer memory 28 and their respective second destination. The short point-to-point buses therefore are power efficient. Only one buffering circuit, the buffer memory 28 is required to implement the design-specific number of memory modules. In one embodiment the memory modules may be distributed around the global memory buffer 16 in order to keep access latency approximately the same for all memory modules. High speed communication between any of the one or more processors 12 and each of the memory modules 20-23 is possible. The communication link to the communication decode unit 26 is a high speed link, such as optical, RF wireless (e.g. UWB) or metal links using LVDS or any combination thereof. The communication decode unit 26 functions to receive various requests from the memory controller 14. The communication decode unit 26 translates whatever encoding is used by the memory controller 14 to access any of the memory modules 20-23. Various packet-based communication protocols may be implemented by the one or more processors 12 and the memory controller 14. Such protocols include, by way of example only, protocols such as RapidIO, PCI Express and HyperTransport. The decode unit 26 may provide control signals to other logic blocks (not shown) within the global memory buffer 16.

In particular, one embodiment includes a packet-based protocol having ordered data/control packets that support flow control and multiple prioritized transactions. Other embodiments can be readily formed using packet-based protocols to be created in the future.

The communication decode unit 26 is conventional logic circuitry that determines, according to a predetermined protocol, how accesses to memory modules 20-23 are handled. The system memory controller 32 provides control signals to the buffer memory in the form of enable and clock signals to regulate the timing and control of memory accesses to each of memory modules 20-23. For quick and direct memory accesses, the DMA 36 is used to implement accesses to memory modules 20-23 that do not need to involve the system memory controller 32 and/or the memory controller 14 during actual transfers of data among memory modules 20-23. Therefore, the DMA 36 provides efficiency in power and time of operation.

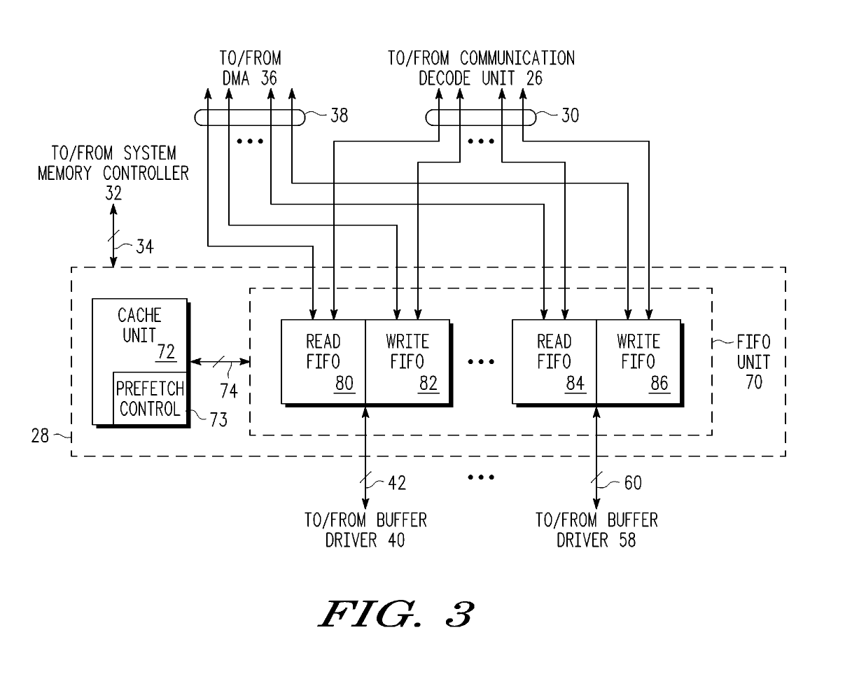

Referring to FIG. 3 there is provided an example implementation of the buffer memory 28 of FIG. 2. In the illustrated form there is provided within the buffer memory both a cache unit 72 and a FIFO (first-in, first-out) unit 70 that are coupled via a bidirectional multi-conductor bus 74. The FIFO unit 70 may be implemented with various types of data storage circuitry and is typically a plurality of registers. Another implementation of the FIFO unit 70 uses conventional flip-flop circuits. The FIFO unit 70 has a plurality of pairs of a Read FIFO and a Write FIFO. A Read FIFO and a corresponding Write FIFO are connected to a respective one of the memory modules of FIG. 2 via a respective buffer driver as illustrated in FIG. 2. Thus for N memory modules, where N is an integer, there are N Read FIFOs and N Write FIFOs. In the illustrated form a Read FIFO 80 and a Write FIFO 82 are connected to and from the buffer driver 40 via bus 42. Similarly, a Read FIFO 84 and a Write FIFO 86 are connected to and from the buffer driver 58 via bus 60. The Read FIFO 80 and the Read FIFO 84 each has a first input/output terminal connected to a conductor that forms bus 38 for communication to and from the DMA 36. The Read FIFO 80 and the Read FIFO 84 each has a second input/output terminal connected to a conductor that forms bus 30 for communication to and from the communication decode unit 26. The Write FIFO 82 and the Write FIFO 86 each has a first input/output terminal connected to a conductor that forms bus 38 for communication to and from the DMA 36. The Write FIFO 82 and the Write FIFO 86 each has a second input/output terminal connected to a conductor that forms bus 30 for communication to and from the communication decode unit 26. The system memory controller 32 is connected to both the cache unit 72 and the FIFO unit 70 of buffer memory 28 via bus 34. It should be understood that cache unit 72 is a conventional cache memory circuit, such as a static random access memory (SRAM), and associated control logic. The storage capacity or size of each of cache unit 72 and the FIFO unit 70 is application-dependent and may vary from implementation to implementation.

In operation, communication between the one or more processors 12 and any of the memory modules 20-23 is facilitated by using the FIFO unit 70 within the global memory buffer 16. When a request to read data in any of the memory modules 20-23 is made, the communication decode unit 26 and the system memory controller 32 perform address decoding in a conventional manner to access the correct memory module for reading or writing. The appropriate buffer driver is activated to drive the accessed data into a corresponding one of the read FIFOs such as Read FIFO 80. Data is then output synchronously from FIFO Unit 70 to the communication decode unit 26 for appropriate handling to transmit back to the requesting processor of the one or more processors 12 via the high-speed communication channel 18. Should the high-speed communication channel 18 not be timely available, the data in the Read FIFO 80 is communicated via bus 74 for storage in the cache unit 72. When the high-speed communication channel 18 does become available according to whatever arbitration protocol is implemented in the memory system 10, the data is then sourced to the high-speed communication channel 18 from the cache unit 72. In an alternate form the read data may be concurrently stored in both the FIFO unit 70 and the cache unit 72 at the same time when accessed from one of the memory modules 20-23. It should be noted that the arrangement of a cache unit 72 and a FIFO unit 70 provides several efficiencies. The cache unit 72 frees up the FIFO unit 70 from stalls should the high-speed communication channel 18 not be available when data is ready to be output from the FIFO unit 70. Additionally, the cache unit 72 is decoupled from the loading that exists at the input/output terminals of the Read FIFOs and Write FIFOs and thus does not slow down the operation of the memory system 10. Significant area savings and power savings are provided by the use of a single or global buffer memory 28 with a plurality of memory modules 20-23.

When a request to write data to any of the memory modules 20-23 is made from one of the one or more processors 12, the communication decode unit 26 and the system memory controller 32 perform address decoding in a conventional manner to identify the location of the address where data is to be written. The appropriate control signals are activated by the system memory controller 32 to drive the accessed data into a corresponding one of the Write FIFOs such as Write FIFO 86. Data is then output synchronously from FIFO Unit 70 to the appropriate memory module by the system memory controller 32 activating the appropriate buffer driver, such as buffer driver 58. In one form the write data is also stored in an addressed location of the cache unit 72 as assigned by the system memory controller 32. Storage of the data in cache unit 72 permits subsequent use of the data by any resource in memory system 10 if desired. By now it should be appreciated that memory system 10 provides support for simultaneous communications with two or more memory modules.

The organization of the data in cache unit 72 may be simplified to allocate storage regions within the cache unit 72 based upon input/output terminals or ports of the buffer memory. In other words, the cache storage in cache unit 72 is allocated or assigned on a memory module basis. Each memory module has an assigned address or address range within cache unit 72. The assigned address information may either be permanent or be permitted to be selectively changed by a user. In addition to simplifying the address assignment, organization and coherency of the cache unit 72, such an assignment guarantees that each memory module has a predetermined amount of cache storage that is available. It should be understood that any dynamic variation of these assignments may be implemented if the costs associated with this additional control is offset by having this additional functionality. In another embodiment the cache unit 72 data storage may be assigned with a least recently used protocol. In one form the cache unit 72 is implemented with prefetch control logic 73 that creates a protocol for what information in the FIFO unit 70 gets cached and what information does not get cached. In some applications the prefetch control logic 73 implements a prefetch logic function. In this form a prefetch of data from certain ones of the memory modules or from certain types of memory operations is performed. The prefetching of data into the cache unit 72 can assist in the speed of operation for all of the memory access types described herein.

Another advantage of having cache unit 72 is that the presence of cache unit 72 makes possible the communication of data directly between memory modules using different bus speeds without requiring the overhead of the system memory controller 32 and/or memory controller 14 during actual transfer of data among the memory modules 20-23. The cache unit 72 permits data that is stored to be transferred to any of the memory modules under control of the DMA 36. Use of the DMA 36 is less overhead and power to the memory system 10 and can permit continued use of the FIFO unit 70 under control of the system memory controller 32. Should the memory system 10 require that data be transferred from memory module 22 to memory module 20, a transfer of the data from memory module 22 to cache unit 72 via the FIFO unit and bus 74 may be implemented. Under control of the DMA 36 the data is output from the cache unit 72 back to the appropriate FIFO of the FIFO unit 70 to complete the module-to-module transfer. The power management unit 33 can also be signaled at the beginning of such a memory operation and the module-to-module transfer can be dynamically varied to occur at a slower rate when transfers are not as time sensitive as transfers utilizing the high-speed communication channel 18. As a result significant power savings can be obtained at no cost to the visible operating performance of the memory system 10. The power management unit 33 may also be implemented to have the additional flexibility to dynamically alter the power supply voltage and clocking of the communication decode unit 26 and buffer memory 28 based upon the amount of loading or activity of the system memory controller 32. In one form, during periods of high demand on the memory controller 32 a maximum power supply voltage and maximum clocking rate can be used to enhance the speed of operation of the memory system 10. When demand on the memory controller 32 falls, the power supply voltage can be reduced to conserve power within the memory system 10. The dynamic monitoring by the power management unit 33 of system conditions can be focused around various criteria other than demand on the memory controller 32. For example, a measurement of the bandwidth utilization of the high-speed communication channel 18 is one criteria that may be used by the power management unit 33.

Other power management features within memory system 10 that can be implemented by the power management unit 33 include the establishment of predetermined power modes for the memory system 10. Such power modes can be entered and modified either under software control when the one or processors 12 executes such software or can be entered and changed by the use of hardware control terminals connected to the power management unit 33. When hardware control terminals are implemented, an external user may dynamically set and control the power mode for the memory system 10.

The DMA 36 may directly write predetermined default values into each of the Read FIFOs and Write FIFOs and thus into the cache unit 72. This operational feature may be useful for certain modes such as during a system reset or during start-up. The ability to program the buffer memory 28 to known initial values is also a valuable feature for the test purposes previously discussed. For example, all memory modules may be simultaneously initialized with predetermined data or test patterns as opposed to slowly sequentially initializing each memory module. Thus a substantial reduction in testing time is accomplished for initialization.

By now it should be appreciated that there has been provided a single, centralized or global memory buffer that may be implemented as a single hub chip within a memory system. The global memory buffer may be used on a mother board (i.e. printed circuit board or other type of substrate or support frame). Point-to-point connections between a high-speed bandwidth communication channel and a memory module, such as a DIMM, are provided. In another embodiment several closely spaced DIMMs may include a memory module and interconnection that approximate the advantages of point-to-point. The memory system described herein also performs at significantly lower latency and power than conventional systems having the same number of memory modules.

Because the various apparatus implementing the present invention are, for the most part, composed of electronic components and circuits known to those skilled in the art, circuit details have not been explained in any greater extent than that considered necessary as illustrated above, for the understanding and appreciation of the underlying concepts of the present invention and in order not to obfuscate or distract from the teachings of the present invention.

Some of the above embodiments, as applicable, may be implemented using a variety of different information processing systems. For example, although FIG. 1 and the discussion thereof describe an exemplary memory system architecture, this exemplary architecture is presented merely to provide a useful reference in discussing various aspects of the invention. Of course, the description of the architecture has been simplified for purposes of discussion, and it is just one of many different types of appropriate architectures that may be used in accordance with the invention. Those skilled in the art will recognize that the boundaries between logic blocks are merely illustrative and that alternative embodiments may merge logic blocks or circuit elements or impose an alternate decomposition of functionality upon various logic blocks or circuit elements. Additionally, the total number of memory modules may be varied so that a user can dynamically add more memory modules or remove memory modules that are coupled to the buffer memory 28. The system memory controller 32 will detect such changes and dynamically alter the control to the memory system in response to a change in the number of memory modules to optimize both power and clock speed to the buffer memory 28.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Also for example, in one embodiment, the illustrated elements of memory system 10 are circuitry located on a single support structure and within a same device. Alternatively, memory system 10 may be distributed and located in physically separate areas. Also for example, memory system 10 or portions thereof may be soft or code representations of physical circuitry or of logical representations convertible into physical circuitry. As such, memory system 10 may be embodied in a hardware description language of any appropriate type.

Furthermore, those skilled in the art will recognize that boundaries between the functionality of the above described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

All or some of the software described herein, the memory cache coherency protocol, and any packet data transmission protocol may be received elements of memory system 10, for example, from computer readable media such as memory 35 or other media on other computer systems. Such computer readable media may be permanently, removably or remotely coupled to an information processing system such as memory system 10. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.; and data transmission media including computer networks, point-to-point telecommunication equipment, and carrier wave transmission media, just to name a few.

In one embodiment, memory system 10 is implemented in a computer system such as a personal computer system. Other embodiments may include different types of computer systems. Computer systems are information handling systems which can be designed to give independent computing power to one or more users. Computer systems may be found in many forms including but not limited to mainframes, minicomputers, servers, workstations, personal computers, notepads, personal digital assistants, electronic games, automotive and other embedded systems, cell phones and various other wireless devices. A typical computer system includes at least one processing unit, associated memory and a number of input/output (I/O) devices.

In one form there is herein provided a memory system having a plurality of memory modules. Each of the plurality of memory modules has at least two integrated circuit memory chips. A global memory buffer has a plurality of ports. Each port is coupled to a respective one of the plurality of memory modules. The global memory buffer stores information that is communicated with the plurality of memory modules. The global memory buffer has a communication port for coupling to a high-speed communication link. In one form the global memory buffer includes a cache memory and a unit of first-in, first-out (FIFO) storage registers. In another form at least one of the cache memory and the unit of first-in, first-out (FIFO) storage registers include assignable data storage that is dynamically partitionable into areas. Each of the areas is assigned to a respective memory module of the plurality of memory modules. In another form at least one of the cache memory and the unit of first-in, first-out (FIFO) storage registers include data storage that is assigned under control of a memory controller coupled to the cache memory and the unit of first-in, first-out (FIFO) storage registers. In yet another form the cache memory further includes prefetch logic for a prefetch of data from one or more of the plurality of memory modules or from one or more predetermined types of memory to improve speed of operation of the memory system. In another form once data is stored in the first-in, first-out (FIFO) storage registers, data is clocked through the first-in, first-out (FIFO) storage registers without logic circuit dependencies. In yet another form the global memory buffer further includes a direct memory access (DMA). The direct memory access permits point-to-point transfers among the plurality of memory modules without use of an external memory controller. In another form each of the plurality of memory modules is coupled to the global memory buffer by respective buses that are substantially equal length buses. The equal length buses distribute the loading of the memory system which provides a balancing effect for the speed of operation. In another form the plurality of memory modules are connected to the global memory buffer with buses having a slower communication speed than the high-speed communication link. In another form the system includes power management circuitry within the global memory buffer for controlling power supply values and clock rates within the memory system based on predetermined criteria. In yet another form the power management circuitry modifies power supply values and clock rates in the memory system to implement data transfers between any two of the plurality of memory modules at a slower data rate than data transfers between any of the plurality of memory modules and the high-speed communication link. In another form at least a portion of data is communicated between two of the plurality of memory modules and the global memory buffer during a same time. In another form at least two different processors are serviced during at least a portion of a same time by communicating data between the global memory buffer and the plurality of memory modules. In another form the high-speed communication link is an ultra wideband (UWB) link, an optical link, a low voltage differential signaling channel or any combination thereof. In another form the high-speed communication link uses a packet-based protocol having ordered packets that support flow control and multiple prioritized transactions.

In one form there is provided a memory system including a plurality of memory modules. Each of the plurality of memory modules includes at least two integrated circuit memory chips. A global memory buffer has a plurality of ports. Each of the plurality of ports is coupled to a respective one of the plurality of memory modules via a respective one of a plurality of buses, the global memory buffer storing information that is communicated with the plurality of memory modules, the global memory buffer having a communication port for coupling to a high-speed communication link, wherein at least two of the plurality of buses communicate data at different communication rates. In another form the global memory buffer further includes a cache memory and a unit of first-in, first-out (FIFO) storage registers, at least one of which has data storage assigned under control of a memory controller. The cache memory includes prefetch logic for a prefetch of data.

In another form there is provided a method of communicating data in a memory system. A plurality of memory modules is provided. Each of the plurality of memory modules includes at least two integrated circuit memory chips. A plurality of ports of a global memory buffer is coupled to a respective one of the plurality of memory modules. Information that is communicated with the plurality of memory modules is stored in the global memory buffer, wherein the global memory buffer includes a communication port for coupling the information to a high-speed communication link. In one form the global memory buffer is formed with a cache memory having a prefetch unit for prefetching data and a set of partitioned registers. Each partition within the set of partitioned registers corresponds to and is coupled to a predetermined one of the plurality of memory modules for communicating the information between said plurality of memory modules and the high-speed communication link.

Although the invention is described herein with reference to specific embodiments, various modifications and changes can be made without departing from the scope of the present invention as set forth in the claims below. For example, any type of memory module having two or more integrated circuit chips may be used. Typically each memory module will have a common support structure, such as a printed circuit board, but that is not required. For example, some applications may require the use of multiple printed circuit boards per memory module. Various types of memory circuits may be used to implement the cache and various register storage devices may be used to implement the described FIFOs. Other storage devices in addition to a FIFO may be used. For example, in some protocols a single, register storage could be implemented. In other embodiments a LIFO, last-in first-out storage device could be used. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

The term “coupled,” as used herein, is not intended to be limited to a direct coupling or a mechanical coupling.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A memory system comprising:
a plurality of memory modules, each of the plurality of memory modules comprising at least two integrated circuit memory chips; and
a global memory buffer having a plurality of ports, each of the plurality of ports being coupled to a respective one of the plurality of memory modules, the global memory buffer storing information that is communicated with the plurality of memory modules, the global memory buffer having a communication port for coupling to a high-speed communication link.

2. The memory system of claim 1 wherein the global memory buffer further comprises a cache memory and a unit of first-in, first-out (FIFO) storage registers.

3. The memory system of claim 2 wherein at least one of the cache memory and the unit of first-in, first-out (FIFO) storage registers comprises assignable data storage that is dynamically partitionable into areas, each of the areas being assigned to a respective memory module of the plurality of memory modules.

4. The memory system of claim 3 wherein at least one of the cache memory and the unit of first-in, first-out (FIFO) storage registers comprises data storage that is assigned under control of a memory controller coupled to the cache memory and the unit of first-in, first-out (FIFO) storage registers.

5. The memory system of claim 4 wherein the memory controller implements a test function to test one or more of the plurality of memory modules.

6. The memory system of claim 2 wherein the cache memory further comprises prefetch logic for a prefetch of data from one or more of the plurality of memory modules or from one or more predetermined types of memory to improve speed of operation of the memory system.

7. The memory system of claim 2 wherein once data is stored in the first-in, first-out (FIFO) storage registers, the data is clocked through the first-in, first-out (FIFO) storage registers without logic circuit dependencies.

8. The memory system of claim 1 wherein the global memory buffer further comprises a direct memory access (DMA), the direct memory access permitting point-to-point transfers among the plurality of memory modules without use of an external memory controller.

9. The memory system of claim 1 wherein each of the plurality of memory modules is coupled to the global memory buffer by respective buses that are substantially equal length buses.

10. The memory system of claim 1 wherein the plurality of memory modules are connected to the global memory buffer with buses having a slower communication speed than the high-speed communication link.

11. The memory system of claim 1 further comprising power management circuitry within the global memory buffer for controlling power supply values and clock rates within the memory system based on predetermined criteria.

12. The memory system of claim 11 wherein the power management circuitry modifies power supply values and clock rates in the memory system to implement data transfers between any two of the plurality of memory modules at a slower data rate than data transfers between any of the plurality of memory modules and the high-speed communication link.

13. The memory system of claim 1 wherein at least a portion of data is communicated between two of the plurality of memory modules and the global memory buffer during a same time.

14. The memory system of claim 1 wherein at least two different processors are serviced during at least a portion of a same time by communicating data between the global memory buffer and the plurality of memory modules.

15. The memory system of claim 1 wherein the high-speed communication link comprises an ultra wideband (UWB) link, an optical link, a low voltage differential signaling channel or any combination thereof.

16. The memory system of claim 1 wherein the high-speed communication link uses a packet-based protocol having ordered packets that support flow control and multiple prioritized transactions.

17. A memory system comprising:
a plurality of memory modules, each of the plurality of memory modules comprising at least two integrated circuit memory chips; and
a global memory buffer having a plurality of ports, each of the plurality of ports being coupled to a respective one of the plurality of memory modules via a respective one of a plurality of buses, the global memory buffer storing information that is communicated with the plurality of memory modules, the global memory buffer having a communication port for coupling to a high-speed communication link, wherein at least two of the plurality of buses communicate data at different communication rates.

18. The memory system of claim 17 wherein the global memory buffer further comprises a cache memory and a unit of first-in, first-out (FIFO) storage registers, at least one of which has data storage assigned under control of a memory controller, the cache memory comprising prefetch logic for a prefetch of data.

19. A method of communicating data in a memory system comprising:
providing a plurality of memory modules, each of the plurality of memory modules comprising at least two integrated circuit memory chips;
coupling a plurality of ports of a global memory buffer to a respective one of the plurality of memory modules; and
storing information that is communicated with the plurality of memory modules in the global memory buffer, wherein the global memory buffer comprises a communication port for coupling the information to a high-speed communication link.

20. The method of claim 19 further comprising:
forming the global memory buffer with a cache memory having a prefetch unit for prefetching data and a plurality of partitioned registers, each partition within the plurality of partitioned registers corresponding to and coupled to a predetermined one of the plurality of memory modules for communicating the information between said plurality of memory modules and the high-speed communication link.
